(19) United States
(12) Patent Application Publication
(10) Pub. No.: US 2009/0144771 A1
(43) Pub. Date: Jun. 4, 2009

(54) Electronic service guide broadcaster and method of processing an electronic service guide

(75) Inventors: Menno Remco Bangma, Nootdorp (NL); Franklin Selgert, Berkel en Rodenrijs (NL)

Correspondence Address: MICHAELSON & ASSOCIATES, P.O. BOX 8489, RED BANK, NJ, 07701-8489, US

(73) Assignee: KONINKLIJKE KPN N.V., The Hague (NL)

(21) Appl. No.: 12/315,084

(22) Filed: Nov. 26, 2008

(30) Foreign Application Priority Data
Nov. 30, 2007 (EP) 07023227.7

(51) Int. Cl. H04N 5/445

(52) U.S. Cl. 725/39

(57) ABSTRACT

The invention relates to a method of processing an ESG of a mobile device is proposed. The method includes the step of storing ESG data for the ESG. The ESG data contains service information data. The service information data comprises location dependent service information data. The method also involves receiving mobile device location data. The received mobile device location data is suitably ready for further processing or may comprise information from which the location data can be determined and/or calculated. The processing of the location dependent service information data is dependent on the received mobile device location data.

### FIELD OF THE INVENTION

The invention relates to an electronic service guide broadcaster and to a method of processing an electronic service guide. More specifically, the invention relates to a method of processing an electronic service guide of a mobile device and an electronic service guide broadcaster adapted to provide an electronic service guide for such a mobile device.

### BACKGROUND OF THE INVENTION

Within the next few years multiple service providers will broadcast services to mobile device via terrestrial and satellite based broadcast and multicast networks, such as DVB-H, T-DMB, ISDB-T, DAB-IP, MBMS etc. Such services are generally known as Mobile TV services, where audiovisual content and files are distributed via a point to multipoint network to mobile end-user devices. The description of the contents of such Mobile TV is typically available in a so called Electronic Service Guide (ESG). Such an ESG functions as the entry-point for the terminal to all Mobile TV services that are available on the broadcast channel or interactive channel.

To receive a broadcasting service in a mobile broadcasting system, a terminal receives an ESG. The ESG comprises ESG data relating to the ESG service and structure. ESG data includes service information data containing a program guide (metadata including, e.g., title, description, genre, time), subscription and billing information (price, URL to acquire the proper credentials required to consume the service), access method information (SDPs, IP addresses, MPEG2-TS PIDs etc), interactivity information (e.g., voting or gambling) and auxiliary data. The service information data, often structured in tables, provides information of the content service (audio, video and/or files). The content service can then be received using the ESG.

Due to the mobile nature of the service consumption, the services descriptions that are applicable might change, and/or not all service descriptions should be available for the end-user at all locations. Such a change can occur because the end-user moves into an area with a broadcast network that has other characteristics such as more/less bandwidth, or because the end-user is moving out of coverage of one or more broadcast networks. The restriction might also origin from the fact that service providers offer certain service descriptions or certain aspects of the service description in certain areas or prevent certain service descriptions or certain aspects of the service description from being available in certain area.

It is known in the art to provide location based restrictions on the content itself, e.g., to black-out certain services. The access to the service is in this case restricted either by not broadcasting the contents of a service or by disallowing the access to such a service. The ESG can thus present information to the end-user on services that are not available or accessible. Furthermore, this approach does not allow for cases in which a service can still be consumed with other (location specific) meta-data for the end-user or has different subscription information.

WO 2007/058763 discloses a method and system for accessing media content. The system comprises digital media having a first digital media file and a second digital media file. The first digital media file has first metadata corresponding to a first location and the second digital media file has second metadata corresponding to a second location. The second location is remote with respect to the first location. A server storing the digital media stores a first list of digital media and a second list of digital media wherein the first list of digital media indicates that the first digital media file is accessible at the first location and wherein the second list of digital media indicates that the second digital media file is accessible at the second location. A first terminal is electrically connected to the server via a communication network wherein the first terminal accesses and communicates with the server via the communication network. The first terminal is movable between the first location and the second location. A locating device is provided that is electrically connected to the server. The server determines whether the first terminal is positioned at the first location or the second location via the locating device. The server transmits the first list of digital media to the first terminal which is located at the first location. The server transmits the second list of digital media to the first terminal which is located at the second location. The first terminal accesses the first digital media file from the server via the first list of digital media. The first terminal accesses the second digital media file from the server via the second list of digital media.

The prior art method and system for updating the ESG is cumbersome in that a quasi-continuous connection with the server is required and that updating of the ESG is no longer possible if such a connection fails or is otherwise not available.

In summary, there exists a need in the art for an improved method and system for processing an ESG of a moving mobile device.

### SUMMARY OF THE INVENTION

One or more embodiments of the invention provide an improved method and system for processing an electronic service guide (ESG) of a moving mobile device.

A first embodiment includes a method of processing an ESG of a mobile device. Processing may include the rendering of the ESG on a display of the mobile device or the triggering of other operations (visible or non-visible for the user of the mobile device) by the mobile device. The method includes the step of storing ESG data for the ESG. The ESG data contains service information data. The service information data comprise location dependent service information data. The method also involves receiving mobile device location data. It should be assumed that the received mobile device location data may, e.g., be ready for further processing or may comprise information from which the location data can be determined and/or calculated. The processing of the location dependent service information data is dependent on the received mobile device location data.

Some implementations include a computer program, an electronic medium and/or a mobile device that are capable of executing the method.

In a further embodiment, an electronic service guide broadcaster is adapted for broadcasting ESG data. The ESG data contain service information data comprising location dependent service information data. The ESG broadcaster is configured to transmit at least one location descriptor associated with said location dependent service information data.

Instead of requiring a quasi-continuous connection between a mobile device and a server that provides ESG data in dependence of a location communicated by the mobile device to the server, the above-described method makes sure that the location dependency of the location dependent service information data is already locally available at the mobile device side. A change of location does not require communication with a server for updating the ESG, but merely internal processing by an ESG controller at the mobile device by taking account of the stored location restrictions in order to display the applicable ESG or to trigger appropriate actions for the new location. Of course, the mobile device location data may still be received from a server. The proposal allows the distribution of the location dependent ESG data by broadcasting.

Yet another example has the advantage that the ESG displayed to the user of the mobile device corresponds to the service(s) available at the current position of the mobile device. Information on unavailable or non-offered services is not displayed.

In one refinement, service applications can be executed in dependence on the actual location of the mobile device. As an example, if a particular service is available only in a particular area, the URL of the server having the credentials for this service is only relevant in this area. The service application for acquiring the subscription may then be executed using the URL only if the mobile device is in that area.

Another embodiment has the advantage that the location dependency of the location dependent service information data can be remotely communicated to the mobile devices. In particular, the ESG data may comprise one or more location descriptors containing information of the location dependency of the location dependent service information data. ESG data is typically transmitted in ESG containers or ESG fragments. The location descriptors may be either part of the ESG containers or be contained in a separate container. Providing the location descriptor(s) in the containers allows a faster access to the location descriptor(s). The separate container with location descriptors can be referred to when a location restriction applies. The location descriptors are stored at the mobile device together with the other ESG data.

Other alternatives have the advantage of efficiency and an appropriate declaration of the ESG. In these embodiments, location descriptors can be re-used easily by implementing the location descriptors in the announcement channel, sometimes also referred to as a service discovery channel. Since the location descriptors should be stored by the mobile device and the amount of location descriptors on the announcement channel may be considerable, a method may be implemented wherein only those location descriptors are stored that comply with particular criteria. An example of a criterion may be the distance between the current location of the mobile device and the area indicated by the location descriptor(s).

Yet another embodiment has the advantage that the service information data may be processed in dependence on the geographical area wherein the mobile device is. In particular, this exemplary embodiment has the advantage that in a particular area of a third party, this third party may impose an ESG for the mobile device, whereas outside this area, the ESG of, for example, a network operator applies. The ESG may contain information of both the network operator and the third party.

Another exemplary aspect of some embodiments defines various methods for receiving and/or determining the mobile device location data.

The mobile device location data may also be obtained from a local position transmitter, such as a location transmitter in a sports stadium, a shopping mall, a government building etc.

Features and advantages will be further illustrated with reference to the attached drawings, which schematically show a preferred embodiment according to the invention. It will be understood that the invention is not in any way restricted to this specific and preferred embodiment.

### BRIEF DESCRIPTION OF THE DRAWINGS

FIG. 1 shows a schematic illustration of a communication system;

FIG. 2 shows an example of an announcement channel and a service guide delivery channel according to an embodiment of the invention;

FIG. 3 shows a schematic illustration of a mobile device;

FIGS. 4A and 4B show examples of a mobile device moving from a first location to a second location;

FIGS. 5A and 5B show schematic illustrations of a program guide; and

FIG. 6 shows a flow chart according to an embodiment of an exemplary method according to the invention.

### DETAILED DESCRIPTION OF THE DRAWINGS

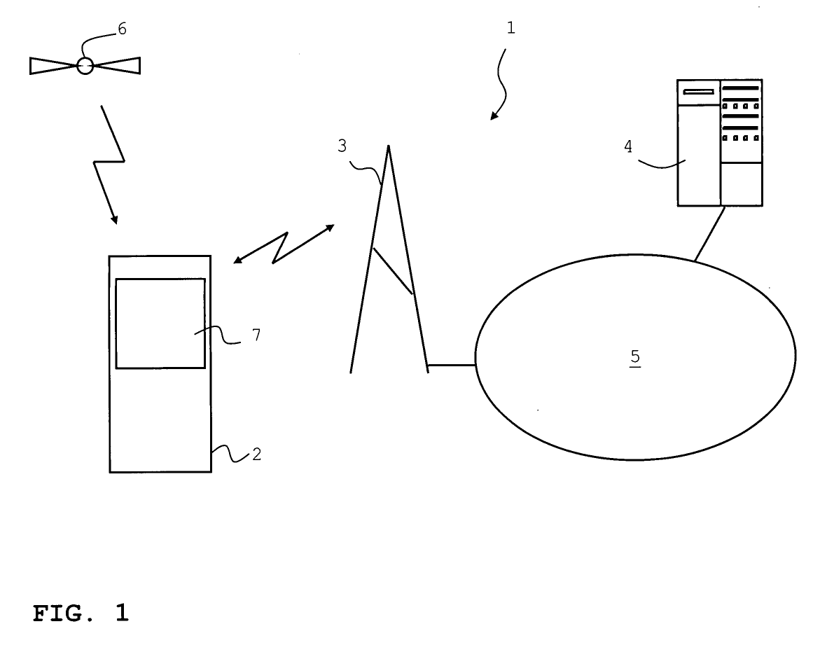

In FIG. 1, a mobile broadcast communication system 1 (e.g., a television broadcast system or a file distribution system) is shown, wherein a mobile device 2 has mobile access to a network 3 connected to a server 4 via a network 5. The mobile device 2 is capable of determining its location by means of a satellite system 6.

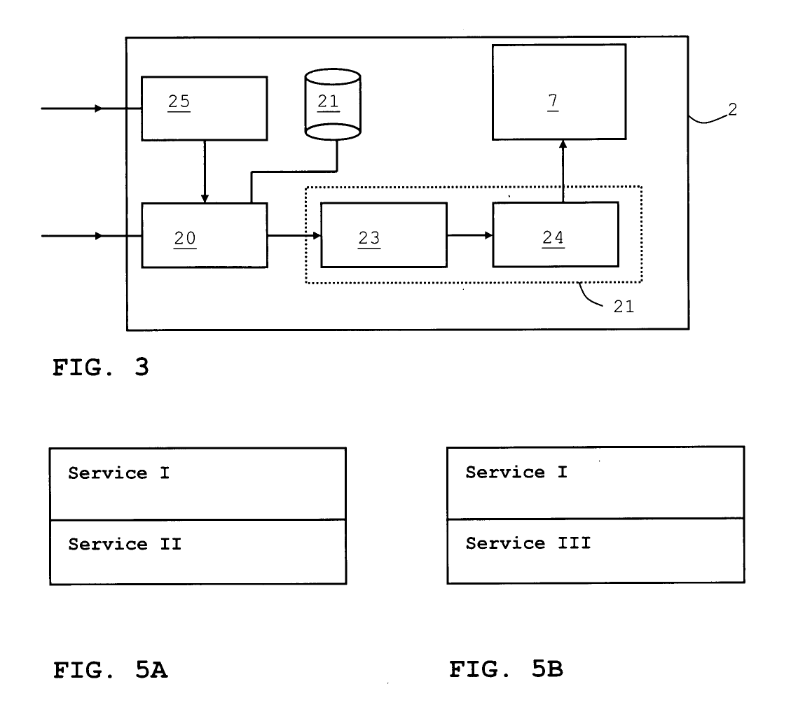

The mobile device 2, described in further detail with reference to FIG. 3, may for example be a mobile phone, a personal digital assistant (PDA), a portable computer (laptop) etc. The mobile device has a display 7 for displaying an electronic service guide (ESG).

The network 3 is a network capable of providing mobile broadcast services to the mobile device 2. The network may, for example, comprise a DVB-H, T-DMB, ISDB-T, DAB-IP or MBMS network.

The server 4 in FIG. 1 may represent a plurality of servers. The server 4 provides the ESG data via the network 5 and the network 3 to the mobile device 2. The content service selectable in the ESG on the display 7 may originate from a different server.

The mobile device 2 is capable of receiving, determining, analyzing or calculating its location. In FIG. 1, the mobile device 2 determines the location from a GPS satellite system 6 in a manner known in the art. However, other location determination systems may be applied, either in addition or as an alternative. As an alternative, the mobile device 2 may receive location information data from the network 3 or from the server 4.

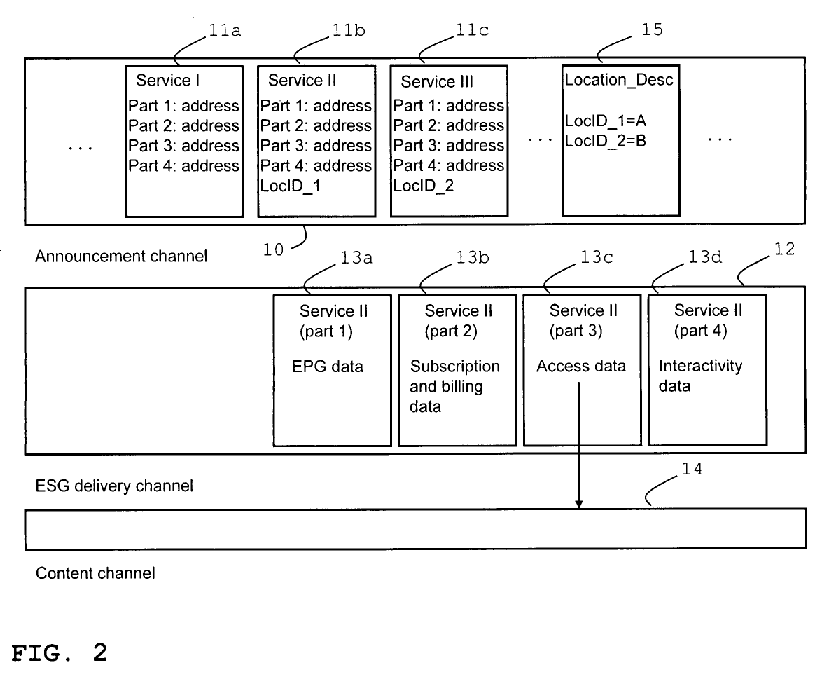

The ESG data provided to the mobile device 2 may be transmitted, e.g., by broadcasting, over the network 3 in a manner shown in FIG. 2.

Typically, the ESG data are separated into ESG fragments or ESG containers and put on the service guide delivery channel. The structure of the ESG and the addresses of the containers are announced on the announcement channel 10. The announcement channel 10 itself can typically be found on a fixed or predefined address or identifier, such as a fixed IP address, or a fixed PID number on a MPEG2 transport stream. Further information on the manner of providing ESG data can be found in the OMA (Open Mobile Alliance) document “Service Guide for Mobile Broadcast Services”, candidate version 1.0 of Sep. 25, 2007.

In FIG. 2, the announcement channel 10 announces the existence of three services I, II and III in corresponding delivery descriptors 11a, 11b, 11c. The service information for each service is stored in four ESG data containers (delivery units) 13a, 13b, 13c and 13d of the ESG delivery channel 12, the address of which is declared on the announcement channel 10. The first container 13a contains the electronic program data (e.g., name, description, start time, end time etc.), the second container 13b contains the subscription and billing data (price, contact address for purchase etc.), the third container 13c contains the access data (access address, access parameters) and the fourth container 13d contains the interactivity data. It should be appreciated that the ESG data may be organized differently in the ESG containers; the electronic program data may, e.g., be distributed over various containers. The access data of the third container 13c provides the required information for tuning to the content channel of FIG. 2, indicated by the arrow.

In an embodiment of the invention, the announcement channel 10 comprises an additional location delivery descriptor 15 “Location_Desc”. Also, the delivery descriptors 11a, 11b, 11c may, where applicable, contain a location identifier referring to a particular entry of the additional location delivery descriptor 15. In FIG. 2, the delivery unit 11b of service II has a location identifier LocID_1 referring to location A, whereas the delivery unit 11c of service III has a location identifier LocID_2 referring to location B.

In another embodiment of the invention, the location information of a service is part of the ESG data containers 13a, 13b, 13c and 13d.

FIG. 3 is a schematic illustration of a mobile device 2 according to an embodiment of the invention.

The mobile device 2 contains an EPG controller 20, a memory 21 and a processor 22 capable of executing a service application 23 and a media application 24. The media application 24 is adapted for rendering media, including the ESG, on the display 7 of the mobile device 2. Furthermore, the mobile device 2 has a location processor 25 for receiving and/or determining the location of the mobile device 2, e.g., by using the GPS system (see, e.g., FIG. 1).

The ESG controller 20 receives the announcement channel of FIG. 2. From the announcement channel, the ESG controller learns that service II is only applicable for location A and service III is only applicable for location B. The ESG controller 20 stores the ESG data of the ESG delivery channel in the memory 21.

An example wherein the service information data processing relates to the rendering of the service information data on the display 7 of the mobile device 2 will be described in further detail below. However, it should be appreciated that other forms of location dependent processing have been envisaged. As an example, it may be that if a particular service is available only in a particular area (e.g., area B), then when the mobile device 2 enters this area, the service application 23 for acquiring the subscription may be executed using the URL applicable for this area.

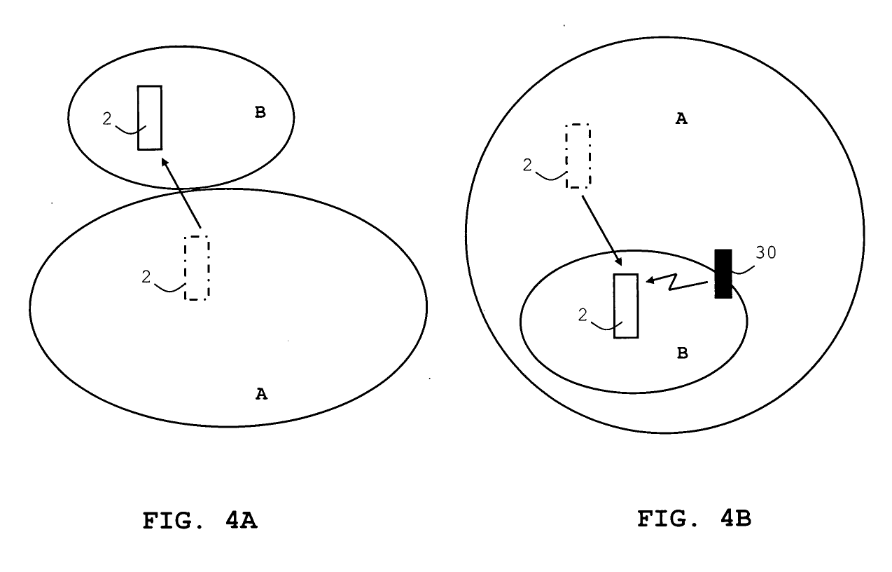

An example of a method according to an embodiment of the invention will be described with reference to FIGS. 4A-4B, 5A-5B and 6.

FIGS. 4A and 4B show two situations wherein a mobile device 2 moves from first area A to a second area B. In FIG. 4B, the first area A contains the second area B. In the case of FIG. 4B, the second area B may, for example, be a sports stadium, within a bigger area (first area A) of a telecommunications network provider. The location information, in this embodiment, is provided by a local position transmitter 30.

FIGS. 5A and 5B illustrate a very simple example of an ESG displayed on the display 7 of the mobile device 2. In the case of FIG. 5A, the mobile device 2 is in the area A. In the case of FIG. 5B, the mobile device 2 is in the area B.

Service I is displayed in both the ESG of FIG. 5A and of FIG. 5B, since this service is location independent. Therefore, service I is displayed irrespective whether the mobile device 2 is in area A or B.

In general, the mobile device 2 at some point receives ESG data including service information data, the service information data comprises location dependent service information data (Step 51).

In FIG. 4A, if the mobile device 2 is in area A (step 52), then the ESG on the display 7 will be that of FIG. 5A (step 53). If the mobile device 2 moves to area B (shown by the arrow), then this location change is sensed by or communicated to the location processor 25 (step 54). The ESG controller 20 takes account of the location change and retrieves the ESG data applicable to the new location from the memory 21. Consequently, the ESG on the display will automatically change to that of FIG. 5B (step 56).

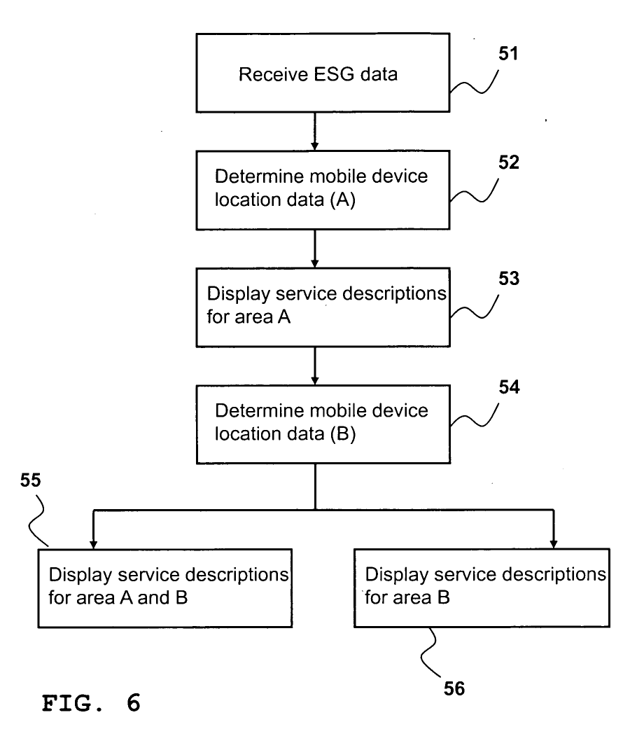

In FIG. 4B, if the mobile device 2 is in the area A that is not also covered by area B (step 52), then the ESG on the display 7 will again be that of FIG. 5A (step 53). If the mobile device 2 moves to area B (shown by the arrow), then this location change is sensed by or communicated to the location processor 25 as a result of information obtained from position transmitter 30 (step 54). The ESG controller 20 takes account of the location change and retrieves the ESG data applicable to the new location from the memory 21. Consequently, the ESG on the display will automatically change to that of FIG. 5B. In this situation, it is stored in the memory 21 that the ESG data for area B take precedence over the ESG data for area A (right branch of FIG. 6) (step 56). This information may be obtained from an exclusive tag in the announcement channel and/or from the ESG delivery channel. However, alternatively, the ESG on the display 7 of the mobile device 2 may display both service II and III, if such precedence information is not available (left branch in FIG. 6) (step 55). The tag may also be a conditional tag, indicating that the ESG for area B should be displayed solely only when it is available. Otherwise, the ESG of FIG. 5A should be displayed.

It is significant that the mobile device 2 not only contains the ESG data but also contains the location information for the processing of these data. This location information may be broadcast to the mobile device and is readily available for processing when appropriate. Consequently, it is not required to have an external connection to signal a particular location to an external device and to retrieve ESG data in response to this signaled location.

1. A method of processing an electronic service guide (ESG) of a mobile device comprising the steps of:
storing ESG data for said ESG, said ESG data containing service information data, wherein said service information data comprises location dependent service information data;
receiving mobile device location data; and
processing said location dependent service information data in dependence of said received mobile device location data.

2. The method according to claim 1, wherein said mobile device comprises a display and said step of processing said location dependent service information data comprises rendering said location dependent service information data on said display in dependence of said received mobile device location data.

3. The method according to claim 1, wherein said mobile device comprises at least one service application and said step of processing said location dependent service information data comprises processing said location dependent service information by said service application in dependence of said received mobile device location data.

4. The method according to claim 1, further comprising the step of receiving said ESG data.

5. The method according to claim 4, wherein said ESG data comprises at least one location descriptor for one or more of said location dependent service information data.

6. The method according to claim 1, further comprising the step of receiving an announcement channel, said announcement channel comprising at least one location descriptor for one or more of said location dependent service information data.

7. The method according to claim 1, wherein first location dependent service information data applies in a first geographical area and second location dependent service information data applies in a second geographical area, and further comprising:
processing at least one of said first location dependent service information data and said second location dependent service information data in dependence of the presence of said mobile device in at least one of said first geographical area and second geographical area.

8. The method according to claim 7, wherein said second geographical area is part of said first geographical area and wherein said processing at least one of said first location dependent service information data and said second location dependent service information data further comprises processing said second location dependent service information data in precedence over said first location dependent service information.

9. The method according to claim 7, wherein both said first and second location dependent data are processed.

10. The method according to claim 1, wherein said mobile device determines said mobile device location data by at least one selected from the following group:
a global positioning satellite receiver for determining GPS coordinates;
means for determining a device location from information received from a radio access network; and
a location data receiver for receiving device location data from a location server.

11. The method according to claim 1, wherein said mobile device determines said mobile device location data from data received from local position transmitters.

12. A computer program for processing an electronic service guide (ESG) of a mobile device comprising software code portions that when run by a processor, performs the following steps:
storing ESG data for said ESG, said ESG data containing service information data, wherein said service information data comprise location dependent service information data;
receiving mobile device location data; and
processing said location dependent service information data in dependence of said received mobile device location data.

13. The computer program according to claim 12, further comprising software code portions capable of executing the steps of claims 5.

14. An electronic medium storing a computer program for processing an electronic service guide (ESG) of a mobile device comprising software code portions that when run by a processor, executes the following steps:
storing ESG data for said ESG, said ESG data containing service information data, wherein said service information data comprise location dependent service information data;
receiving mobile device location data; and
processing said location dependent service information data in dependence of said received mobile device location data.

15. A mobile device containing the electronic medium of claim 14.

16. An electronic service guide broadcaster adapted for broadcasting ESG data, said ESG data containing service information data comprising location dependent service information data, wherein said broadcaster is also configured to transmit at least one location descriptor associated with said location dependent service information data.

17. The electronic service guide broadcaster according to claim 16, wherein said broadcaster is configured to broadcast said location descriptor on an announcement channel for announcing said ESG data.

18. The electronic service guide broadcaster according to claim 16, wherein said broadcaster is configured to broadcast said location descriptor with said ESG data.
